(19) United States
(12) Patent Application Publication
(10) Pub. No.: US 2017/0016129 A1
(43) Pub. Date: Jan. 19, 2017

(54) METHOD FOR PRODUCING CATALYTICALLY ACTIVE POWDERS FROM METALLIC SILVER OR FROM MIXTURES OF METALLIC SILVER WITH SILVER OXIDE FOR PRODUCING GAS DIFFUSION ELECTRODES

(71) Applicant: Covestro Deutschland AG, Leverkusen (DE)

(72) Inventors: Andreas Bulan, Langenfeld (DE); Rainer WEBER, Odenthal (DE); Michael STELTER, Wegefarth (DE); Hartmund BOMBACH, Freiberg (DE); Katja PALM, Freiberg (DE)

(21) Appl. No.: 15/124,086

(22) PCT Filed: Mar. 6, 2015
(86) PCT No.: PCT/EP2015/054772

§ 371 Date: Sep. 7, 2016

(30) Foreign Application Priority Data
Mar. 11, 2014 (DE) 102014204372.7

(51) Int. Cl. C25C 1/20; H01M 12/08; H01M 4/90; C25B 1/46; C25C 5/02

(52) U.S. Cl. CPC C25C 1/20; C25B 1/46; C25C 5/02; H01M 4/9041; H01M 4/9016; H01M 12/08

(57) ABSTRACT

The invention relates to an electrochemical method for producing catalytically active powder from mixtures of metallic silver, optionally with silver oxides, which are particularly suitable for use in oxygen-consuming electrodes, in particular for use in chlor-alkali electrolysis. The invention also relates to the use of said electrodes in chlor-alkali electrolysis or fuel cell technology or in metal/air batteries.

The invention relates to the production of catalytically active powders based on metallic silver with silver oxides having a particle size distribution of d₉₀<20 μm, d₅₀<10 μm and d₁₀<3 μm, for use as catalyst material for gas diffusion electrodes, in particular oxygen-depolarized electrodes for the reduction of oxygen in alkaline solutions. The latter are particularly suitable for use in chloralkali electrolysis. The invention relates in particular to a method for producing these catalytically active silver powders or pulverulent mixtures by the novel electrochemical mode of operation.

Various chemical and electrochemical methods for producing powders composed of metallic silver or of silver oxide are known from the prior art. The invention indicates a novel possibility for producing catalytically active powders composed of metallic silver or of mixtures of metallic silver and silver oxides having a defined composition and particle size for use as catalyst material for gas diffusion electrodes by an electrochemical method.

Proposals for producing silver powders by electrochemical processes are known from the literature. For the production of silver powders, the current density and the silver content in the electrolyte generally have to be selected so that deposition occurs under limiting current density conditions.

Processes of this type for producing silver powders by electrochemical processes in which electrolytes based on acidic silver salt solutions, in particular nitric acid silver salt solutions, are employed, with the pH of the electrolytes preferably being selected in the strongly acidic pH range, are known and are described, inter alia, in M. G. Pavlović in al. “J. Appl. Electrochem.” 18:61-65, 1978 and K. I. Popov et al. “J. Appl. Electrochem,” 21:50-54, 1991. However, deposition from cyanide-containing electrolytes is also known (A. T. Kuhn et al. “Surface Technology”, 16:3-14, 1982).

It is stated in various references that additives which firstly lead to an improvement in the conductivity of the electrolyte, for example alkali metal salts, and secondly are said to alter the deposition product in respect of its particle size and shape are added to the electrolytes for the electrochemical production of silver powders, as described, inter alia, in N. A. Smagurowa, “Powder Metall Met Ceram”, 1:103-109, 1962 and DE3119635A1.

Apart from the deposition of silver powders under constant direct current conditions, processes using pulsed direct current, as described, inter alia, in K. I. Popov et al. “J. Appl. Electrochem,” 21:50-54, 1991, are also known for producing silver powders.

U.S. Pat. No. 4,603,118 describes a process for producing a catalytically active electrode material for oxygen-depolarized cathodes, in which a silver salt solution is mixed with a PTFE dispersion and the silver salt is reduced to silver by addition of a reducing agent. Here, the PTFE should be selected so that the PTFE dispersion is stable and the reduction of the silver salt also takes place. Formaldehyde is used as reducing agent and the preferred pH is from 7 to 11. The reaction temperature at which the reduction of the silver salt is to take place is preferably 0-50° C., more preferably 0-15° C. A silver content of 70-80% is preferred, so that the amount of starting material is preferably such that the weight ratio of silver/solids of the organic dispersion is from 20:80 to 90:10, more preferably from 70:30 to 85:15.

A disadvantage of all available detergents for stabilizing the dispersion is that they subsequently have to be removed again, which results in an additional working step and incurs the risk that the detergents are not removed without leaving a residue, if detergents remain in the ODE, these can be eluted during the electrolysis and contaminate the electrolytes. Furthermore, the detergents could leave the electrode more hydrophilic, so that the pore system is flooded with electrolyte and the performance of the electrode is substantially impaired.

U.S. Pat. No. 3,836,436 describes a process for the electrochemical production of silver-containing catalysts for the production of ethylene oxide. Here, the silver catalyst is obtained by pulsed electrolysis of a silver salt solution in the presence of a complexing agent. The current flows for 3-10 seconds followed by an interruption of 3-60 seconds. After 10-15 cycles, the current is reversed for 1-60 seconds, The silver salt solution having a silver concentration of 0.1-10 g/l is complexed by means of ammonia which is used in concentrations of 3-50 mol per gram atom of silver. In addition, a buffer solution consisting of, for example, glycerol and sodium hydroxide or borax and sodium hydroxide is used in order to keep the pH in the range from 9 to 12.5. Insoluble anodes composed of, for example, graphite, platinum, platinum-rhodium or titanium are used. The cathode consists of silver, stainless steel or the anode material. The electrolytic deposition of the silver powder is carried out with vigorous stirring of the electrolyte at current densities of 0.1-0.5 A/cm², preferably 0.2-0.3 A/cm², and temperatures of 0-80° C., preferably 10-40° C. A disadvantage here is the addition of buffer substances which likewise have to be removed from the electrode material again, which requires an additional production step.

GB1400758 describes an electrochemical production process for metallic silver powders having catalytic properties and particle sizes of less than 1500 Å and more than 300 Å, which are employed in the synthesis of ethylene or ethylene oxide. The silver powder produced at the cathode is removed from the latter by mechanical methods such as brushing, vibration or vigorous stirring of the electrolyte. The electrolyte consisting of a water-soluble silver salt and a complexing agent, for example ammonia, serves as source of the silver ions. A buffer system keeps the pH at 10-14. The electrolysis is preferably carried out in the presence of a protective colloid such as carboxymethyl cellulose which is intended to prevent agglomeration of the silver powder. The electrolytic production of silver powder takes place at low temperatures of 10-50° C. and current densities of 2-50 mA/cm². The incompletely removed complexing agents, ammonium compounds, buffer substances or protective colloids have a disadvantageous effect on the performance of the electrode.

While the literature describes a series of processes for the electrochemical production of silver powders, there are no processes in which powders composed of a mixture of metallic silver and silver oxides are produced in one process stage in an electrolysis process.

### DESCRIPTION OF THE INVENTION

It is an object of the invention to discover a novel process for producing electrocatalytically active silver-containing powder which is suitable for producing oxygen-depolarized electrodes and avoids the above-described disadvantages of the known production processes and, in particular, has a higher electrocatalytic activity. The object is achieved by a process for the electrochemical production of powders which consist of metallic silver or of a mixture of metallic silver and silver oxides having a defined particle size range, based on the anodic dissolution of a silver anode and the cathodic deposition of the silver powders or deposition of silver with simultaneous formation of silver oxide, so that a silver/silver oxide powder mixture which is catalytically active and is particularly suitable for producing oxygen-depolarized electrodes is produced from an electrolyte containing a silver salt.

The invention provides a process for producing electrochemically active silver-containing powder from metallic silver by anodic dissolution of the metallic silver to form silver ions in an electrolyte containing a silver salt, preferably silver nitrate or silver sulfate, and a further alkali metal salt, preferably alkali metal nitrate or alkali metal sulfate, and cathodic deposition of particles comprising at least silver and silver oxide from the electrolyte, with the deposited particles being removed from the cathode and isolated, in particular purified and dried, characterized in that the pH during the deposition is not more than 9 and at least 1.

It has surprisingly been found that when a mixture of silver and silver oxide is produced by cathodic deposition, this mixture is particularly active. In particular, it has been found that silver oxide can be produced in the cathodic reduction of silver salts. This was not to be expected.

Oxygen-depolarized cathodes obtainable by the novel production process contain an electrically conductive support and also a gas diffusion layer and a catalyst layer based on the powder composed of metallic silver and silver oxide produced by the novel production process.

The novel process is characterized by the selection of the production parameters, e.g. current density, type and concentration of the silver ion carrier, type and concentrations of the electrolyte additives and the temperature, matched to the desired physical, chemical, electrochemical and catalytic properties of the powders composed of metallic silver or powder mixtures of metallic silver and silver oxides produced by a single-stage electrolysis process and in particular by the targeted regulation of the pH of the electrolyte employed and to the properties of the powder.

The temperature of the electrolyte for the electrolytic production of the catalytically active silver powders or powders consisting of metallic silver and silver oxides is, in a preferred embodiment of the process, from 0 to 50° C. The novel electrochemical production process is particularly preferably carried out at a temperature in the range 10.40° C. for producing catalytically active silver/silver oxide particles having preferred physical, chemical and electrochemical properties.

The novel production process can be carried out, in particular, at a current density of at least 200 A/m², particularly preferably from 200 to 5000 A/m², very particularly preferably 300-5000 A/m², in the electrolytic deposition.

The electrolyte is based on a water-soluble silver salt which can be used in concentrations up to its solubility limit. Furthermore, the electrolyte can contain a water-soluble alkali metal salt in order to increase the conductivity of the electrolyte; the concentration of the water-soluble alkali metal salt can be selected in a wide range up to its solubility limit. If the pH is not regulated, the pH of the electrolyte rises from greater than 1 at the beginning of the electrolytic deposition to above 9.

However, particular preference is given to a process in which the pH rises by not more than 2 pH units during the deposition.

Preference is given to a novel electrochemical process in which the pH of the electrolyte is kept constant during the deposition.

The cathodic current density is selected in a range in which pulverulent silver is deposited together with silver oxides, i.e. in the region of the diffusion-limited current density, preferably at least 200 A/m², particularly preferably in the range 200-5000 A/m², in particular in the range 300-5000 A/m², so that the powder mixtures having the physical, chemical and electrochemical properties preferred in the oxygen-depolarized cathodes for the envisaged use are deposited cathodically.

The electrolytic deposition is carried out in an electrolysis cell consisting of at least a silver anode, an electrolyte which contains at least one water-soluble silver salt, in particular silver nitrate, and optionally an acid, in particular an acid corresponding to the silver salt, especially nitric acid, and at least one cathode consisting of an electrically conductive material such as silver, aluminum or stainless steel.

The silver salt concentration of the electrolyte can be selected in the range from 1 to 100 g/l, with the concentration also being able to be determined by the solubility limit of the silver salt in the electrolyte. Preference is given to a very low concentration for producing preferred physical, chemical and electrochemical properties of the electrolytically and optionally chemically deposited catalytic powder consisting of a mixture of metallic silver with silver oxides. As salt, it is possible to use, for example, silver nitrate.

To increase the conductivity of the electrolyte and to modify the morphology of the deposited silver salts, at least one electrolyte salt, in particular one containing ions from the group of alkali and alkaline earth metals, can be added in the concentration range up to its respective solubility limit.

For example, it is possible to add alkali metal nitrates, likewise alkali metal sulfates, but preferably alkali metal nitrates. The concentration of the water-soluble alkali metal salt can vary in a wide range, and the solubility of the alkali metal salt can determine the concentration. Preference is given to a very high concentration in order to keep the voltage drop over the electrolyte and the bath voltage as low as possible; particular preference is given to a concentration of up to 200 g/l of alkali metal salt. Preference is also given to concentrations of the water-soluble alkali metal salt which have an advantageous effect on the regulation of the pH of the electrolyte over the duration of the production process according to the invention and the preferred physical, chemical and electrochemical properties of the catalytically active silver powder resulting therefrom.

When sodium nitrate is added, the electrolyte salt content is particularly preferably in the range from 20 to 150 g/l.

The pH of the electrolyte at the beginning of the electrolytic deposition is at least 1 and not more than 9, preferably at least 1 and not more than 8. The pH is preferably set by addition of nitric acid. Monitoring and regulation of the pH can contribute to the production of preferred physical, chemical and electrochemical properties of the powders composed of metallic silver or mixtures of metallic silver and silver oxides. The pH is preferably regulated by targeted selection of production parameters such as power density, type and concentration of the silver ions and electrolyte additives and also temperature so that catalytically active powders composed of metallic silver or mixtures of metallic silver and silver oxide are produced cathodically.

Many additives, for example comprising surface-active substances such as sodium lauryl sulfate, are known for influencing the properties of silver powders and silver-containing powders produced by electrochemical and chemical processes. Making use of these additives for influencing the physical, chemical and electrochemical properties of the catalytically active silver powders and silver-containing powders in a targeted manner has to be decided by a person skilled in the art.

After production of the silver/silver oxide powders according to the invention, they are filtered off from the electrolyte. This can, for example, also be carried out continuously during the electrolysis by means of suitable flow conditions when the electrolyte is circulated by pumping. The silver crystallites growing on the cathode can likewise be removed mechanically, e.g. by means of scrapers, at regular intervals so that they can be removed from the cell with the electrolyte circulated by pumping. After filtration, the powder is washed with deionized water so that the nitrate content is less than 0.5% by weight in the silver/silver oxide powder. The powder is subsequently dried at in particular, 60-100° C.; drying can also be carried out under reduced pressure.

The catalytically active powders obtainable by the novel process comprise metallic silver and silver oxide with a total oxygen content of the powder of 0.01-6.4% by weight, preferably 1.0-6.2% by weight.

The inventive catalytically active silver powders or powder mixtures of metallic silver and silver oxides are characterized in particular by a, preferably bimodal, particle size distribution having an average particle diameter d₅₀ of not more than 40 μm, preferably not more than 25 μm, particularly preferably not more than 10 μm, measured by the laser light scattering method. In particular, the novel powder has a bimodal particle size distribution. In particular, up to 10% of the particles have a diameter of less than 0.8 μm, and the main peak of the particle distribution is in the range 6-8 μm.

The specific surface area of the catalytically active silver powders or powder mixtures of metallic silver and silver oxides produced by the production process described in the present invention is at least 0.1 m²/g, preferably at least 0.5 m²/g, particularly preferably in the range 0.5-1.5 m²/g, determined by multipoint BET determination (instrument: Coulter SA 3100).

The silver powder or silver/silver oxide produced according to the invention is, in particular, processed together with PTFE in powder form by the dry production process described below to give a powder mixture. The resulting powder mixture is characterized by good powder flow, which leads to improved processability of these powders for the production of gas diffusion electrodes. For the purposes of the invention, good powder flow means that the sieve residue of the powder mixture sieved on a sieve having a mesh opening of 1 mm is less than 2.0% by weight.

The invention further provides a gas diffusion electrode containing at least a silver powder or powder containing silver and silver oxide obtained from the process of the invention as electrocatalyst. Preference is given to a novel gas diffusion electrode which is characterized in that the gas diffusion layer and the layer containing the electrocatalyst are formed by a single layer.

The manufacture and description of the ODE in which silver or silver- and silver oxide-containing powders produced by the process of the invention are used will be illustrated below, without the validity of the invention being restricted to the specific embodiments of ODE production indicated below.

An ODE usually has both hydrophilic and hydrophobic regions. Hydrophobic properties are produced by means of polymers such as polytetrafluoroethylene (PTFE). Regions having the PTFE component are hydrophobic, and no electrolyte can penetrate into the pore system of the ODE here. The catalyst itself has to be hydrophilic.

The production of PTFE-catalyst mixtures is in principle carried out by, for example, use of dispersions composed of water, PTFE and catalyst. An alternative to this wet production process is production by dry mixing from PTFE powder and catalyst powder.

Dispersion processes are selected mainly for electrodes used with polymeric electrolytes; for example, successfully introduced in the PEM (polymer electrolyte membrane) fuel cell or HCl-ODE membrane electrolysis (WO2002118675).

The catalyst powder of the invention can be used in both ODE production processes.

In dry processes, the catalyst is intensively mixed with a polymer component The powder mixture produced can be shaped by pressing, preferably by pressing by means of a roller process, to produce a film-like structure which is subsequently applied to the support (DE 3,710,168 A2; EP 144,002 A2). A preferred alternative which can likewise be employed is described in DE 102005023615 A2; here, the powder mixture is sprinkled onto a support and pressed together with the latter.

Here, the powder mixture consists of at least a catalyst and a binder. The powder according to the invention can be used as catalyst. The binder is preferably a hydrophobic polymer, particularly preferably polytetrafluoroethylene (PTFE). Particular preference is given to using powder mixtures which consist of from 50 to 99.5% by weight of catalyst and from 0.5 to 50% by weight of PTEE. The powder mixture can contain additional further components, e.g. fillers, containing nickel metal, Raney nickel, Raney silver powders or mixtures thereof and also other chemically and electrochemically inert powders such as zirconium dioxide.

The powder mixture containing a catalyst and a binder forms, after application to the support and pressing together with the support, an electrochemically active layer of the ODE.

The powder mixture is, in a particularly preferred embodiment, produced by mixing of the powders of the catalyst and of the binder and also optionally further components. Mixing is preferably effected in mixing apparatuses which have rapidly rotating mixing elements, e.g. beater knives. To mix the components of the powder mixture, the mixing elements preferably rotate at a speed of from 10 to 30 m/s or at a rotational speed of from 4000 to 15 000 rpm. If the catalyst, e.g. silver/silver oxide, is mixed with PTFE as binder in such a mixing apparatus, the PTFE is stretched to give a thread-like structure and in this way acts as binder for the catalyst, After mixing, the powder mixture is preferably sieved. Sieving is preferably carried out using a sieving apparatus equipped with meshes or the like having a mesh opening of from 0.04 to 8 mm.

The mixing in the mixing apparatus having rotating mixing elements introduces energy into the powder mixture, as a result of which the powder mixture heats up considerably. When the powder heats up too much, an impairment in the ODE performance is observed, and the temperature during the mixing process is therefore preferably from 35 to 80° C. This can be brought about by cooling during mixing, e.g. by addition of a coolant, e.g. liquid nitrogen or other inert heat-absorbing substances. A further possible way of controlling the temperature is to interrupt mixing in order to allow the powder mixture to cool or to select suitable mixing apparatuses or changing the amount of material in the

Application of the powder mixture to the electrically conductive support is effected, for example, by sprinkling. Sprinkling of the powder mixture onto the support can, for example, occur by means of a sieve. It is particularly advantageous to place a frame-like template on the support, with the template preferably being selected so that it just encompasses the support. The thickness of the template can be selected according to the amount of powder mixture to be applied to the support. The template is filled with the powder mixture. Excess powder can be removed by means of a scraper. The template is then removed. It is important here for a PTFE-catalyst powder mixture displaying good powder flow to be present.

In the following step, the powder mixture is, in a particularly preferred embodiment, pressed together with the support. Pressing can, in particular, be carried out by means of rollers, with the force between the roller bodies pressed onto one another during pressing being from 0.01 to 7 kN/cm².

A novel ODE can in principle have a single-layer or multilayer structure. To produce multilayer ODEs, powder mixtures having different compositions and different properties are applied in layers to the support. These layers of different powder mixtures are preferably not pressed individually with the support, but instead are firstly applied to one another and subsequently pressed together with the support in one step. For example, a layer of a powder mixture which has a higher content of the binder, in particular a higher content of PTFE, than the electrochemically active layer, can be applied. Such a layer having a high PTFE content of from 6 to 100% can act as gas diffusion layer.

As an alternative or in addition, a gas diffusion layer composed of PTFE can also be applied. A layer having a high content of PTFE can, for example, be applied as bottom layer directly onto the support. Further layers having different compositions can be applied in order to produce the gas diffusion electrode. In the case of multilayer ODEs, the desired physical and/or chemical properties can be set in a targeted manner. Such properties include, inter alia, the hydrophobicity or hydrophilicity of the layer, the electrical conductivity and the gas permeability. Thus, for example, the gradient of a property can be built up by the magnitude of the property increasing or decreasing from layer to layer.

The ODE produced has a porosity of the catalytically active coating of from 10 to 70%. The thickness of the catalytically active coating of the ODE is preferably from 20 to 1000 μm.

The loading of the electrode with catalytically active component is preferably from 0.5 mg/cm² to 300 mg/cm², preferably from 0.5 mg/cm² to 200 mg/cm². The PTFE-catalyst powder mixture is applied to a support consisting of a material selected from the group consisting of silver, nickel, coated nickel, e.g. with silver or gold, polymer, nickel-copper alloys and coated nickel-copper alloys, e.g. silver-plated nickel-copper alloys, from which sheet-like textile structures have been produced.

The electrically conductive support can in principle be a mesh, nonwoven, foam, woven fabric, braid or expanded metal. The support preferably consists of metal, particularly preferably of nickel, silver or silver-plated nickel, The support can have one or more layers. A multilayer support can be made up of two or more superposed meshes, nonwovens, foams, woven fabrics, braids or expanded metals. The meshes, nonwovens, foams, woven fabrics, braids or expanded metals can be different. They can, for example, have different thicknesses or different porosities or have a different mesh opening, Two or more meshes, nonwovens, foams, woven fabrics, braids or expanded metals can, for example, be joined to one another by sintering or welding. Preference is given to using a mesh composed of nickel having a wire diameter of from 0.04 to 0.4 mm and a mesh opening of from 0.2 to 1.2 mm.

The support of the gas diffusion electrode is preferably based on nickel, silver or a combination of nickel and silver or gilded nickel.

The oxygen-depolarized electrode made using the catalytically active powder composed of metallic silver or mixtures of metallic silver and silver oxides and produced by the process of the invention is, in particular, connected as cathode, in particular in an electrolysis cell for the electrolysis of alkali metal chlorides, preferably of sodium chloride or potassium chloride, particularly preferably of sodium chloride.

The oxygen-depolarized electrode made using the catalytically active powder composed of metallic silver or mixtures of metallic silver and silver oxides and produced by the process of the invention can also be connected as cathode in a fuel cell, Preferred examples of such fuel cells are alkaline fuel cells. A further possible use is a metal-air battery.

The invention therefore further provides for the use of the catalytically active powders composed of metallic silver or mixtures of metallic silver and silver oxides produced by the process of the invention and also the oxygen-depolarized electrode made therefrom for the reduction of oxygen in alkaline solutions, for example as oxygen-depolarized cathode in electrolysis, in particular in chloralkali electrolysis, or as electrode in a fuel cell or as electrode in a metal-air battery.

The invention will be illustrated below by means of the examples, which, however, do not constitute a restriction of the invention.

### EXAMPLE 1

### Process According to the Invention

The production of the catalytically active powder composed of metallic silver or mixtures of metallic silver and silver oxides was carried out in an electrolysis cell consisting of a double-walled vessel having a cell volume of 5 l, a silver anode which was at a distance of 5 cm from each of two stainless steel cathodes. A nitric acid solution having an initial pH of 5.5 and containing 6.35 g/l of silver as silver nitrate and 20 g/l of sodium nitrate served as electrolyte. To bring the electrolyte to an intended temperature of 10° C., the double-walled vessel used as electrolysis cell was connected to a cryostat. The cathodic current density was 500 A/m². The mechanical removal of the cathode precipitate was carried out at intervals of five minutes. Within the first 10 minutes of the electrolytic deposition, a pH of 8 was established, so that the formation of silver hydroxides and silver oxides occurred in parallel to the cathodic silver powder deposition, After an electrolysis time of 90 minutes, the electrolyte containing the catalytically active powder was taken from the electrolysis cell, filtered, the powder was washed with deionized water and subsequently dried at 80° C. for about 24 hours. Characterization of the resulting powder consisting of a mixture of metallic silver and silver oxides indicated a d₅₀ of 6.8 μm, a BET value of 0.63 m²/g and an oxygen content of 4.8%.

0.15 kg of a powder mixture consisting of 7% by weight of PUT powder, Dyneon, grade 2053, 93% by weight of the catalytically active powder according to the invention consisting of a mixture of metallic silver and silver oxides was mixed in a mixer from IKA equipped with a star rotor as mixing element at a rotational speed of 15 000 rpm in such a way that the temperature of the powder mixture did not exceed 55° C. This was achieved by the mixing operation being interrupted and the mixture being cooled. Mixing was carried out a total of four times. After mixing, the powder mixture was sieved using a sieve having a mesh opening of 1.0 mm.

The sieved powder mixture was subsequently applied to a mesh composed of nickel and having a wire thickness of 0.14 mm and a mesh opening of 0.5 mm. Application was carried out with the aid of a 1 mm thick template, with the powder being applied by means of a sieve having a mesh opening of 1 mm. Excess powder which projected beyond the thickness of the template was removed by means of a scraper. After removal of the template, the support together with the applied powder mixture was pressed by means of a roller press using a linear pressing force of 0.19 kN/cm. The sheet-like structure based on silver powder was taken from the roller press.

The ODE was used in the electrolysis of a sodium chloride solution in an electrolyzer having an ion exchange membrane N982WX from DuPONT and a sodium hydroxide gap between ODE and membrane of 3 mm. The ion exchange membrane rested on the anode. As anode, use was made of a commercial noble metal-coated titanium electrode having a coating from DENORA. The anode chamber was supplied with a sodium chloride-containing solution in such a way that the solution running out had an NaCl content of 205 g/l. The cathode chamber was supplied with sodium hydroxide solution in such a way that the sodium hydroxide solution running out from the cell had a concentration of 31.5% by weight. Furthermore, pure oxygen was supplied to the gas side of the cathode chamber in an amount which corresponded to an about 1.5-fold excess over the stoichiometrically required amount of oxygen. The electrolyte temperature was 90° C. The electrolysis voltage was 2.10 V at a current density of 4 kA/m².

In addition, the characterization of the electrochemical behavior of the reduced ODE was carried out with the aid of electrochemical impedance spectroscopy (EIS). The measurements were carried out in a half cell from Gaskatel, in which the cathode process of chloralkali electrolysis can be reproduced. For the experiments, an ODE specimen having the dimensions 7×3 cm was cut out and clamped as cathode in the half cell in such a way that it separates the electrolyte space and the gas space from one another. The effective area of the cathode was 3.14 cm². A platinum foil served as anode and the reverse hydrogen electrode served as reference electrode. A 32% strength by weight sodium hydroxide solution was used as electrolyte. A current density of 4 kA/m² was applied to the ODE and the electrolyte was at the same time heated to 80° C. Oxygen (99.5%) was introduced into the gas space. When the electrolyte temperature of 80° C. had been reached, the EIS measurement was carried out in the frequency range from 100 mHz to 20 kHz. The correction factor for the electrolyte resistance at the current density of 4 kA/m² was determined from the EIS measurement and this was used to correct the potential of the ODE measured under these conditions relative to the reverse hydrogen electrode (RHE). The corrected potential of the oxygen-depolarized electrode was 795 mV relative to the reverse hydrogen electrode (RHE).

### EXAMPLE 2

### Electrode with Silver Powder from Ferro as Comparative Example

A silver powder SF9ED from Ferro was used. This was mixed with 7% by weight of PTFE TF2053 Z from Dyneon in the IKA mill as in example 1 and processed to give the ODE. In processing to give the electrode, the powder could be flattened off only with great difficulty: holes were repeatedly produced in the powder layer. The initial voltage at 1.5 kA/m² was 1.8V. The voltage rose very quickly, so that the experiment was stopped when a voltage of 2.3V had been reached.

### EXAMPLE 3

### Electrode with Silver Powder from Ferro as Comparative Example

A silver powder SFQED from Ferro was used. This was mixed with 7% by weight of PTFE TF2053 Z from Dyneon in the IKA mill as in example 1 and could not be processed to produce the ODE. In processing to produce the electrode, the powder could not be flattened off without tearing holes in the powder layer.

### EXAMPLE 4

### Comparative Example

For the production of the catalytically active silver powder, the electrochemical procedure described in use example 1 was employed. A nitric acid solution having an initial pH of 1.5 and containing 6.35 g/l of silver as silver nitrate but no sodium nitrate served as electrolyte. The cathodic current density was 1500 A/m². During the electrolytic deposition, a pH of the electrolyte of 2 was not exceeded. Characterization of the silver powder obtained indicated a d₅₀ of 21.6 μm, a BET value of 0.11 m²/g and an oxygen content of 0.1%.

The production of the silver-based sheet-like structure as described in use example I gave a perforated ODE.

An intact piece of the ODE could be subjected to electrochemical characterization by means of electrochemical impedance spectroscopy in the half cell as described in use example 1. At a current density of 4 kA/m², the corrected potential of the ODE was 607 mV relative to the SHE and was significantly poorer than that in example 1.

### EXAMPLE 5

For the production of the catalytically active powder composed of metallic silver and silver oxides, the electrochemical procedure described in use example 1 was employed. A nitric acid solution having an initial pH of 1.5 and containing 10 g/l of silver nitrate and 50 g/l of sodium nitrate served as electrolyte. The cathodic current density was 1500 A/m². The pH of the electrolyte rose to 8 over the first 40 minutes of electrolytic deposition. Characterization of the powder obtained indicated a d₅₀ of 8.9 μm, a BET value of 1.5 m²/g and an oxygen content of the catalytically active powder mixture composed of metallic silver and silver oxides of 2.8%.

The production of the silver-based sheet-like structure was carried out as described in use example 1.

The determination of the electrolysis voltage for a sodium chloride solution was carried out as in use example 1. At a current density of 4 kA/m², the electrolysis voltage was 2.11 V.

The electrochemical characterization was carried out by means of EIS measurement as described in use example 1. At a current density of 4 kA/m², the corrected potential of the ODE was 830 mV relative to the RHE and was thus even better than in example 1.

### EXAMPLE 6

For the production of the catalytically active powder composed of metallic silver and silver oxides, the electrochemical procedure described in use example 1 was employed. A nitric acid solution having an initial pH of 1.5 and containing 6.35 g/l of silver as silver nitrate and 150 g/l of sodium nitrate served as electrolyte. The cathodic current density was 1500 A/m². The pH of the electrolyte rose to 8 over the first 30 minutes of electrolytic deposition. Characterization of the mixed powder obtained, composed of metallic silver and silver oxides, indicated a d₅₀ of 6.8 μm, a BET value of 0.88 m²/g and an oxygen content of 3.4%.

The production of the silver-based sheet-like structure was carried out as described in use example 1, The linear pressing force was 0.28 kN/cm.

The determination of the electrolysis voltage for a sodium chloride solution was carried out as in use example 1. At a current density of 4 kA/m², an electrolyte temperature of 90° C. and a sodium hydroxide concentration of 32% by weight, the electrolysis voltage was 2.11 V.

As described in use example 1, the electrochemical characterization was carried out by means of electrochemical impedance spectroscopy. At a current density of 4 kA/m², the corrected potential of the ODE was 794 mV relative to the RHE.

### EXAMPLE 5

For the production of the catalytically active powder composed of metallic silver and silver oxides, the electrochemical procedure described in use example 1 was employed. A nitric acid solution having an initial pH of 5.5 and containing 10 g/l of silver nitrate and 150 g/l of sodium nitrate served as electrolyte. The cathodic current density was 1500 A/m². The pH of the electrolyte rose to 8 over the first five minutes of the electrolytic deposition. Characterization of the silver powder obtained indicated a (d₅₀ of 8.1 μm, a BET value of 0.54 m²/g; and an oxygen content of the catalytically active powder mixture composed of metallic silver and silver oxides of 6.1%.

The production of the silver-based sheet-like structure was carried out as described in use example 1, The linear pressing force was 0.23 kN/cm.

The determination of the electrolysis voltage for a sodium chloride solution was carried out as in use example 1. At a current density of 4 kA/m², an electrolyte temperature of 90° C. and a sodium hydroxide concentration of 32% by weight, the electrolysis voltage was 2.18 V.

The electrochemical characterization was carried out by means of electrochemical impedance spectroscopy as described in use example 1. At a current density of 4 kA/m, the corrected potential of the ODE was 751 mV relative to the RHE.

1.-14. (canceled)

15. A process for producing electrochemically active silver-containing powder from metallic silver comprising anodic dissolution of the metallic silver to form silver ions in an electrolyte containing a silver salt, and a further alkali metal salt, and cathodic deposition of particles comprising at least silver and silver oxide from the electrolyte, with the deposited particles being removed from the cathode and isolated, wherein the pH during the deposition is not more than 9 and at least 1.

16. The process as claimed in claim 15, wherein the electrolyte contains silver ions and also ions from the alkali metal or alkaline earth metal group in the concentration range up to its respective solubility limit.

17. The process as claimed in claim 15, wherein the current density is at least 200 A/m², preferably from 200 to 5000 A/m².

18. The process as claimed in claim 15, wherein the electrochemical production process is carried out at a temperature of the electrolyte of from 0 to 50° C.

19. The process as claimed in claim 15, wherein the pH rises by not more than two units.

20. The process as claimed in claim 19, wherein the pH of the electrolyte is kept constant during deposition.

21. The process as claimed in claim 15, wherein the particles removed from the cathode are purified and dried to such an extent that the nitrate content in the silver/silver oxide powder is less than 0.5% by weight.

22. The process as claimed in claim 15, wherein the isolated powder produced on the cathode comprises metallic silver and silver oxide with a total oxygen content of the powder of 0.01-6.4% by weight.

23. The process as claimed in claim 22, wherein the isolated powder has an average particle diameter d₅₀ of not more than 40 μm.

24. The process as claimed in claim 15, wherein the isolated powder has a specific surface area characterized by a BET value of at least 0.1 m²/g.

25. The process as claimed in claim 15, wherein the powder obtained after isolation has a bimodal particle size distribution.

26. A gas diffusion electrode containing at least a silver powder or a powder containing silver and silver oxide obtained from a process as claimed in claim 15 as electrocatalyst.

27. The gas diffusion electrode as claimed in claim 26, wherein the gas diffusion layer and the layer containing the electrocatalyst are formed by a single layer.

28. A method comprising utilizing the gas diffusion electrode as claimed in claim 26 as oxygen-depolarized cathode in electrolysis or as electrode in a fuel cell or as electrode in a metal/air battery.
